(19) United States
(12) Patent Application Publication
(10) Pub. No.: US 2024/0300154 A1
(43) Pub. Date: Sep. 12, 2024

(54) CONTROL DEVICE OF INJECTION MOLDING MACHINE, INJECTION MOLDING MACHINE, METHOD OF CONTROLLING INJECTION MOLDING MACHINE

(71) Applicant: SUMITOMO HEAVY INDUSTRIES, LTD., Tokyo (JP)

(72) Inventors: Yuta HIROTOMI, Chiba-shi (JP); Koki TSUNEMI, Chiba-shi (JP)

(21) Appl. No.: 18/440,859

(22) Filed: Feb. 13, 2024

(30) Foreign Application Priority Data
Mar. 7, 2023 (JP) 2023-034304

(51) Int. Cl. B29C 45/76; B29C 45/17; B29C 45/77

(52) U.S. Cl. CPC B29C 45/762; B29C 45/1774; B29C 45/77; B29C 2045/776; B29C 2945/76006; B29C 2945/76498; B29C 2945/76551; B29C 2945/76862; B29C 2945/76933

(57) ABSTRACT

An injection molding machine includes an injection member that pushes a molding material and an injection drive source that moves the injection member. A control device of the injection molding machine includes an injection control unit that controls a stop process for stopping a movement of the injection member and a holding pressure process for controlling a pressure acting on the molding material from the injection member, a pressure monitoring unit that monitors an actual value of the pressure in the stop process, and a timing setting unit that sets a timing when the stop process is to be switched to the holding pressure process on the basis of the actual value of the pressure in the stop process and a value offset from a set value of the pressure at a time of start of the holding pressure process to a high pressure side by a predetermined amount.

### CROSS-REFERENCE TO RELATED APPLICATIONS

This application claims priority to Japanese Patent Application No. 2023-034304, filed on Mar. 7, 2023, which is incorporated by reference herein in its entirety.

### BACKGROUND

### Technical Field

Certain embodiments of the present invention relate to a control device of an injection molding machine, an injection molding machine, and a method of controlling an injection molding machine.

### Description of Related Art

According to a method of controlling an injection molding machine disclosed in the related art, in a case where a pressure obtained by a mold internal pressure sensor installed in a mold reaches a pressure set in advance after the start of an injection process, a screw stops at a screw position at that point of time. The screw stops for a time set in advance. After that, a holding pressure process is performed.

A control device of the injection molding machine controls a stop process for stopping a movement of an injection member and a holding pressure process for controlling a pressure acting on a molding material from the injection member. The injection member is, for example, a screw or a plunger. The molding material is, for example, a resin.

The movement of the injection member is stopped in the stop process. Therefore, a pressure acting on the molding material from the injection member is gradually reduced in the stop process. A time of the stop process is set in advance, and the stop process is switched to the holding pressure process when the time has passed.

### SUMMARY

A control device according to an aspect of the present invention is a control device of an injection molding machine including an injection member that pushes a molding material and an injection drive source that moves the injection member. The control device includes an injection control unit that controls a stop process for stopping a movement of the injection member and a holding pressure process for controlling a pressure acting on the molding material from the injection member, a pressure monitoring unit that monitors an actual value of the pressure in the stop process, and a timing setting unit that sets a timing when the stop process is to be switched to the holding pressure process on the basis of the actual value of the pressure in the stop process and a value offset from a set value of the pressure at a time of start of the holding pressure process to a high pressure side by a predetermined amount.

### BRIEF DESCRIPTION OF THE DRAWINGS

FIG. 1 is a diagram showing a state of an injection molding machine according to an embodiment at a time of completion of mold opening.

FIG. 2 is a diagram showing a state of the injection molding machine according to the embodiment at a time of mold clamping.

FIG. 3 is a diagram showing an example of components of a control device as functional blocks.

FIG. 4 is a diagram showing an example of processes of a molding cycle.

FIG. 5 is a diagram showing an example of a screen related to settings in an injection process.

FIG. 6A is a diagram showing a first reference example of an actual value of a pressure in the injection process, FIG. 6B is a diagram showing a second reference example of an actual value of a pressure in the injection process, and FIG. 6C is a diagram showing an example of an actual value of a pressure in the injection process.

### DETAILED DESCRIPTION

In a case where the time of the stop process is excessively long, an actual value of the pressure at a time of completion of the stop process is smaller than a set value of the pressure at a time of start of the holding pressure process. In this case, the pressure for pushing the resin in the stop process is excessively low, so that a flow of the resin may be excessively slow. As a result, for example, a defect in which a part of a molding product is not formed since the resin is not distributed into the mold unit, that is, a so-called short shot, may occur.

Further, in a case where the time of the stop process is excessively short, an actual value of the pressure at the time of completion of the stop process is larger than a set value of the pressure at the time of start of the holding pressure process. In this case, the injection member may be caused to suddenly retreat so that an actual value of the pressure is reduced after the stop process is switched to the holding pressure process. As a result, for example, a defect in which a surface of the molding product is dented, that is, a so-called sink mark, may occur.

It is desirable to provide a technique that suppresses molding defects.

Embodiments of the present invention will be described below with reference to the drawings. The same or corresponding components will be denoted in the respective drawings by the same reference numerals, and the description thereof will be omitted.

### Injection Molding Machine

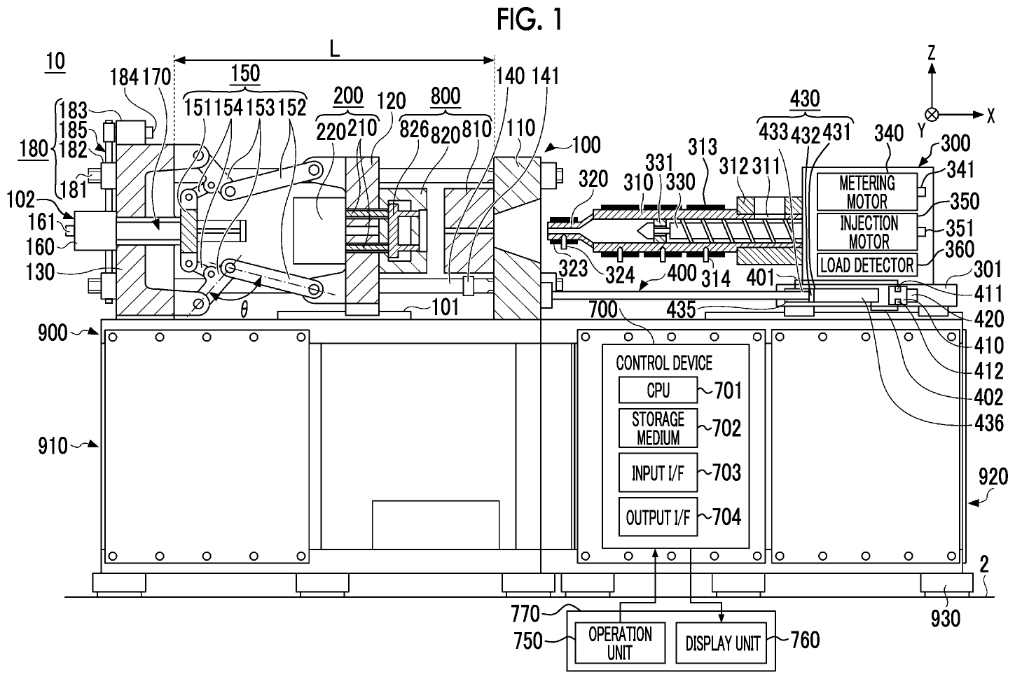

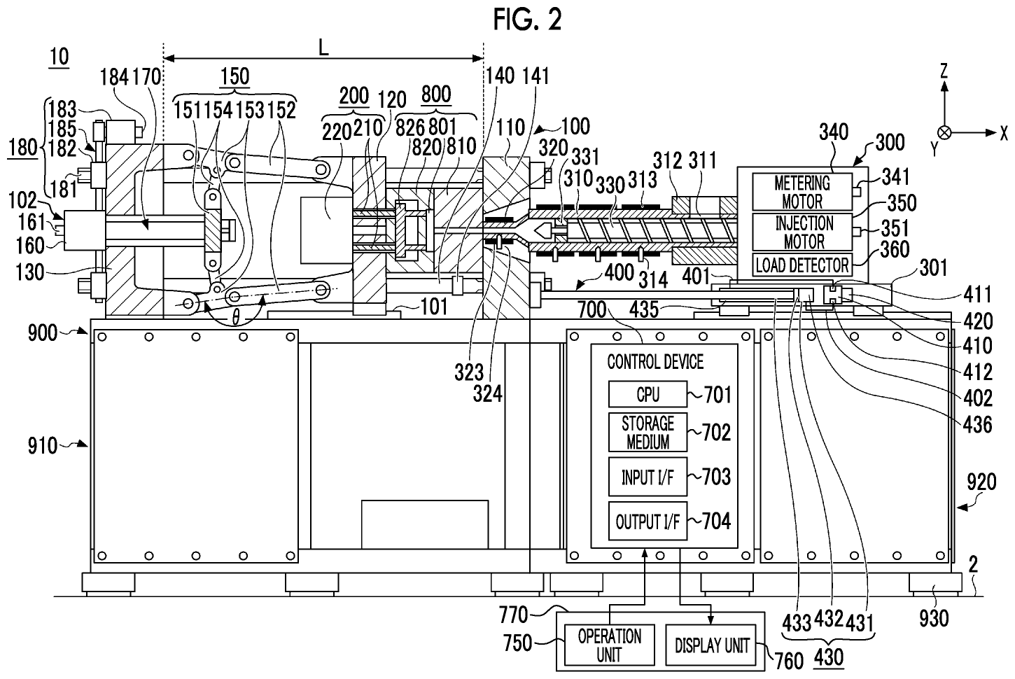

FIG. 1 is a diagram showing a state of an injection molding machine according to an embodiment at a time of completion of mold opening. FIG. 2 is a diagram showing a state of the injection molding machine according to the embodiment at a time of mold clamping. In this specification, an X-axis direction, a Y-axis direction, and a Z-axis direction are directions perpendicular to each other. The X-axis direction and the Y-axis direction indicate horizontal directions, and the Z-axis direction indicates a vertical direction. In a case where a mold clamping unit 100 is of a horizontal type, the X-axis direction is a mold opening/closing direction and the Y-axis direction is a width direction of an injection molding machine 10. A negative side in the Y-axis direction is referred to as an operation side, and a positive side in the Y-axis direction is referred to as a counter-operation side.

As shown in FIGS. 1 and 2, the injection molding machine 10 includes a mold clamping unit 100 that opens and closes a mold unit 800, an ejector unit 200 that ejects molding products molded by the mold unit 800, an injection unit 300 that injects a molding material into the mold unit 800, a moving unit 400 that causes the injection unit 300 to advance and retreat with respect to the mold unit 800, a control device 700 that controls the respective components of the injection molding machine 10, and a frame 900 that supports the respective components of the injection molding machine 10. The frame 900 includes a mold clamping unit frame 910 that supports the mold clamping unit 100, and an injection unit frame 920 that supports the injection unit 300. The mold clamping unit frame 910 and the injection unit frame 920 are installed on a floor 2 via leveling adjusters 930, respectively. The control device 700 is disposed in an internal space of the injection unit frame 920. The respective components of the injection molding machine 10 will be described below.

### Mold Clamping Unit

In the description of the mold clamping unit 100, a moving direction of a movable platen 120 in a case where a mold is to be closed (for example, an X-axis positive direction) will correspond to a front, and a moving direction of the movable platen 120 in a case where the mold is to be opened (for example, an X-axis negative direction) will correspond to a rear.

The mold clamping unit 100 performs mold closing, pressurization, mold clamping, depressurization, and mold opening of the mold unit 800. The mold unit 800 includes a stationary mold 810 and a movable mold 820.

The mold clamping unit 100 is of, for example, a horizontal type, and the mold opening/closing direction of the mold clamping unit 100 is a horizontal direction. The mold clamping unit 100 includes a stationary platen 110 to which the stationary mold 810 is attached, the movable platen 120 to which the movable mold 820 is attached, and a moving mechanism 102 that moves the movable platen 120 with respect to the stationary platen 110 in the mold opening/closing direction.

The stationary platen 110 is fixed to the mold clamping unit frame 910. The stationary mold 810 is attached to a surface of the stationary platen 110 facing the movable platen 120.

The movable platen 120 is disposed to be movable with respect to the mold clamping unit frame 910 in the mold opening/closing direction. Guides 101 that guide the movable platen 120 are laid on the mold clamping unit frame 910. The movable mold 820 is attached to a surface of the movable platen 120 facing the stationary platen 110.

The moving mechanism 102 causes the movable platen 120 to advance and retreat with respect to the stationary platen 110 to perform mold closing, pressurization, mold clamping, depressurization, and mold opening of the mold unit 800. The moving mechanism 102 includes a toggle support 130 that is disposed with an interval between the stationary platen 110 and itself, tie bars 140 that connect the stationary platen 110 to the toggle support 130, a toggle mechanism 150 that moves the movable platen 120 with respect to the toggle support 130 in the mold opening/closing direction, a mold clamping motor 160 that operates the toggle mechanism 150, a motion conversion mechanism 170 that converts a rotary motion of the mold clamping motor 160 into a linear motion, and a mold space adjustment mechanism 180 that adjusts an interval between the stationary platen 110 and the toggle support 130.

The toggle support 130 is disposed with an interval between the stationary platen 110 and itself, and is placed on the mold clamping unit frame 910 to be movable in the mold opening/closing direction. The toggle support 130 may be disposed to be movable along guides laid on the mold clamping unit frame 910. The guides for the toggle support 130 may be common to the guides 101 for the movable platen 120.

In the present embodiment, the stationary platen 110 is fixed to the mold clamping unit frame 910, and the toggle support 130 is disposed to be movable with respect to the mold clamping unit frame 910 in the mold opening/closing direction. However, the toggle support 130 may be fixed to the mold clamping unit frame 910, and the stationary platen 110 may be disposed to be movable with respect to the mold clamping unit frame 910 in the mold opening/closing direction.

The tie bars 140 connect the stationary platen 110 to the toggle support 130 with an interval L between the stationary platen 110 and the toggle support 130 in the mold opening/closing direction. A plurality of (for example, four) tie bars 140 may be used. The plurality of tie bars 140 are disposed parallel to the mold opening/closing direction and extend depending on a mold clamping force. At least one tie bar 140 may be provided with a tie bar strain detector 141 that measures a strain of the tie bar 140. The tie bar strain detector 141 sends a signal indicating a detection result thereof to the control device 700. The detection result of the tie bar strain detector 141 is used for the measurement of a mold clamping force, and the like.

The tie bar strain detector 141 is used in the present embodiment as a mold clamping force detector for measuring a mold clamping force, but the present invention is not limited thereto. The mold clamping force detector is not limited to a strain gauge type and may be of a piezoelectric type, a capacitive type, a hydraulic type, an electromagnetic type, or the like. A position where the mold clamping force detector is attached is also not limited to the tie bar 140.

The toggle mechanism 150 is disposed between the movable platen 120 and the toggle support 130, and moves the movable platen 120 with respect to the toggle support 130 in the mold opening/closing direction. The toggle mechanism 150 includes a crosshead 151 that moves in the mold opening/closing direction and a pair of link groups that is bent and stretched depending on the movement of the crosshead 151. Each of the pair of link groups includes a first link 152 and a second link 153 that are bendably and stretchably connected to each other by a pin or the like. The first link 152 is oscillatingly attached to the movable platen 120 by a pin or the like. The second link 153 is oscillatingly attached to the toggle support 130 by a pin or the like. The second link 153 is attached to the crosshead 151 via a third link 154. In a case where the crosshead 151 is caused to advance and retreat with respect to the toggle support 130, the first and second links 152 and 153 are bent and stretched, and the movable platen 120 advances and retreats with respect to the toggle support 130.

The configuration of the toggle mechanism 150 is not limited to the configuration shown in FIGS. 1 and 2. For example, the number of nodes of each link group is five in FIGS. 1 and 2 but may be four. One end portion of the third link 154 may be connected to the node between the first and second links 152 and 153.

The mold clamping motor 160 is attached to the toggle support 130 and operates the toggle mechanism 150. The mold clamping motor 160 causes the crosshead 151 to advance and retreat with respect to the toggle support 130, so that the first and second links 152 and 153 are bent and stretched to cause the movable platen 120 to advance and retreat with respect to the toggle support 130. The mold clamping motor 160 is directly connected to the motion conversion mechanism 170, but may be connected to the motion conversion mechanism 170 via a belt, pulleys, and the like.

The motion conversion mechanism 170 converts a rotary motion of the mold clamping motor 160 into a linear motion of the crosshead 151. The motion conversion mechanism 170 includes a screw shaft and a screw nut that is screwed to the screw shaft. Balls or rollers may be interposed between the screw shaft and the screw nut.

The mold clamping unit 100 performs a mold closing process, a pressurization process, a mold clamping process, a depressurization process, a mold opening process, and the like under the control of the control device 700.

In the mold closing process, the mold clamping motor 160 is driven to cause the crosshead 151 to advance up to a mold closing completion position at a set movement speed, so that the movable platen 120 is caused to advance and causes the movable mold 820 to touch the stationary mold 810. The position and the movement speed of the crosshead 151 are measured using, for example, a mold clamping motor encoder 161 or the like. The mold clamping motor encoder 161 measures rotation of the mold clamping motor 160, and sends a signal indicating a detection result thereof to the control device 700.

A crosshead position detector for measuring the position of the crosshead 151 and a crosshead movement speed detector for measuring the movement speed of the crosshead 151 are not limited to the mold clamping motor encoder 161, and general detectors can be used. Further, a movable platen position detector for measuring the position of the movable platen 120 and a movable platen movement speed detector for measuring the movement speed of the movable platen 120 are not limited to the mold clamping motor encoder 161, and general detectors can be used.

In the pressurization process, the mold clamping motor 160 is further driven to further cause the crosshead 151 to advance from the mold closing completion position up to a mold clamping position and to generate a mold clamping force.

In the mold clamping process, the mold clamping motor 160 is driven to maintain the position of the crosshead 151 at the mold clamping position. In the mold clamping process, the mold clamping force generated in the pressurization process is maintained. In the mold clamping process, cavity spaces 801 (see FIG. 2) are formed between the movable mold 820 and the stationary mold 810, and the injection unit 300 fills the cavity spaces 801 with liquid molding material. Molding products are obtained in a case where the molding material filling the cavity spaces is solidified.

One cavity space 801 may be provided, or a plurality of cavity spaces 801 may be provided. In the latter case, a plurality of molding products are obtained at the same time. An insert material may be disposed in a part of each cavity space 801, and the other part of each cavity space 801 may be filled with a molding material. Molding products in which the insert material and the molding material are integrated with each other are obtained.

In the depressurization process, the mold clamping motor 160 is driven to cause the crosshead 151 to retreat from the mold clamping position up to a mold opening start position, so that the movable platen 120 is caused to retreat to reduce the mold clamping force. The mold opening start position and the mold closing completion position may be the same position.

In the mold opening process, the mold clamping motor 160 is driven to cause the crosshead 151 to retreat from the mold opening start position up to a mold opening completion position at a set movement speed, so that the movable platen 120 is caused to retreat and causes the movable mold 820 to be separated from the stationary mold 810. After that, the ejector unit 200 ejects the molding products from the movable mold 820.

Set conditions in the mold closing process, the pressurization process, and the mold clamping process are collectively set as a series of set conditions. For example, movement speeds and positions (including a mold closing start position, a movement speed switching position, a mold closing completion position, and a mold clamping position) of the crosshead 151 and mold clamping forces in the mold closing process and the pressurization process are collectively set as a series of set conditions. The mold closing start position, the movement speed switching position, the mold closing completion position, and the mold clamping position are arranged in this order from a rear side toward the front, and indicate starting points and end points of sections in which the movement speeds are set. The movement speed is set for each section. One movement speed switching position may be set, or a plurality of movement speed switching positions may be set. The movement speed switching position may not be set. Only one of the mold clamping position and the mold clamping force may be set.

Set conditions in the depressurization process and the mold opening process are also set in the same manner. For example, movement speeds and positions (including the mold opening start position, the movement speed switching position, and the mold opening completion position) of the crosshead 151 in the depressurization process and the mold opening process are collectively set as a series of set conditions. The mold opening start position, the movement speed switching position, and the mold opening completion position are arranged in this order from a front side toward the rear, and indicate starting points and end points of sections in which the movement speeds are set. The movement speed is set for each section. One movement speed switching position may be set, or a plurality of movement speed switching positions may be set. The movement speed switching position may not be set. The mold opening start position and the mold closing completion position may be the same position. Further, the mold opening completion position and the mold closing start position may be the same position.

The movement speeds, the positions, and the like of the movable platen 120 may be set instead of the movement speeds, the positions, and the like of the crosshead 151. Further, a mold clamping force may be set instead of the position (for example, the mold clamping position) of the crosshead or the position of the movable platen.

The toggle mechanism 150 amplifies the driving force of the mold clamping motor 160 and transmits the amplified driving force to the movable platen 120. The amplification factor of the toggle mechanism 150 is also referred to as a toggle factor. The toggle factor is changed depending on an angle θ between the first and second links 152 and 153 (hereinafter, also referred to as a “link angle θ”).

The link angle θ is obtained from the position of the crosshead 151. In a case where the link angle θ is 180°, the toggle factor is at its maximum.

In a case where a thickness of the mold unit 800 is changed due to replacement of the mold unit 800, a change in a temperature of the mold unit 800, or the like, a mold space is adjusted such that a predetermined mold clamping force is obtained during mold clamping. In the adjustment of a mold space, the interval L between the stationary platen 110 and the toggle support 130 is adjusted such that the link angle θ of the toggle mechanism 150 is a predetermined angle at a time of mold touch when, for example, the movable mold 820 touches the stationary mold 810.

The mold clamping unit 100 includes a mold space adjustment mechanism 180. The mold space adjustment mechanism 180 adjusts the interval L between the stationary platen 110 and the toggle support 130 to adjust a mold space. A timing when a mold space is adjusted is, for example, between the end of a molding cycle and the start of the next molding cycle. The mold space adjustment mechanism 180 includes, for example, screw shafts 181 that are formed at rear end portions of the tie bars 140, screw nuts 182 that are rotatably held by the toggle support 130 not to be capable of advancing and retreating, and a mold space adjustment motor 183 that rotates the screw nuts 182 screwed to the screw shafts 181.

The screw shaft 181 and the screw nut 182 are provided for each tie bar 140. A rotational driving force of the mold space adjustment motor 183 may be transmitted to a plurality of screw nuts 182 via a rotational driving force transmission unit 185. The plurality of screw nuts 182 can be rotated in synchronization. It is also possible to individually rotate the plurality of screw nuts 182 by changing a transmission channel of the rotational driving force transmission unit 185.

The rotational driving force transmission unit 185 includes, for example, gears and the like. In this case, a driven gear is formed on an outer periphery of each screw nut 182, a driving gear is attached to an output shaft of the mold space adjustment motor 183, and an intermediate gear, which meshes with a plurality of driven gears and the driving gear, is rotatably held at a central portion of the toggle support 130. The rotational driving force transmission unit 185 may include a belt, pulleys, and the like instead of the gears.

The operation of the mold space adjustment mechanism 180 is controlled by the control device 700. The control device 700 drives the mold space adjustment motor 183 to rotate the screw nuts 182. As a result, the position of the toggle support 130 with respect to the tie bars 140 is adjusted, so that the interval L between the stationary platen 110 and the toggle support 130 is adjusted. A plurality of mold space adjustment mechanisms may be used in combination.

The interval L is measured using a mold space adjustment motor encoder 184. The mold space adjustment motor encoder 184 measures an amount of rotation and a rotation direction of the mold space adjustment motor 183, and sends signals indicating detection results thereof to the control device 700. The detection results of the mold space adjustment motor encoder 184 are used for the monitoring and control of the position of the toggle support 130 and the interval L. A toggle support position detector for measuring the position of the toggle support 130 and an interval detector for measuring the interval L are not limited to the mold space adjustment motor encoder 184, and general detectors can be used.

The mold clamping unit 100 may include a mold temperature controller that adjusts the temperature of the mold unit 800. The mold unit 800 includes a flow channel for a temperature control medium therein. The mold temperature controller adjusts a temperature of a temperature control medium, which is supplied to the flow channel of the mold unit 800, to adjust the temperature of the mold unit 800.

The mold clamping unit 100 of the present embodiment is of a horizontal type in which a mold opening/closing direction is a horizontal direction, but may be of a vertical type in which a mold opening/closing direction is a vertical direction.

The mold clamping unit 100 of the present embodiment includes the mold clamping motor 160 as a drive unit, but may include a hydraulic cylinder instead of the mold clamping motor 160. Further, the mold clamping unit 100 may include a linear motor for opening and closing the mold and may include an electromagnet for clamping the mold.

### Ejector Unit

In the description of the ejector unit 200, as in the description of the mold clamping unit 100, the moving direction of the movable platen 120 in a case where the mold is to be closed (for example, the X-axis positive direction) will correspond to a front, and the moving direction of the movable platen 120 in a case where the mold is to be opened (for example, the X-axis negative direction) will correspond to a rear.

The ejector unit 200 is attached to the movable platen 120, and advances and retreats together with the movable platen 120. The ejector unit 200 includes ejector rods 210 that eject the molding products from the mold unit 800, and a drive mechanism 220 that moves the ejector rods 210 in the moving direction of the movable platen 120 (X-axis direction).

The ejector rods 210 are disposed in through-holes of the movable platen 120 to be capable of advancing and retreating. Front end portions of the ejector rods 210 are in contact with an ejector plate 826 of the movable mold 820. The front end portions of the ejector rods 210 may be connected to or may not be connected to the ejector plate 826.

The drive mechanism 220 includes, for example, an ejector motor and a motion conversion mechanism that converts a rotary motion of the ejector motor into a linear motion of the ejector rods 210. The motion conversion mechanism includes a screw shaft and a screw nut that is screwed to the screw shaft. Balls or rollers may be interposed between the screw shaft and the screw nut.

The ejector unit 200 performs an ejection process under the control of the control device 700. In the ejection process, the ejector rods 210 are caused to advance up to an ejection position from a standby position at a set movement speed, so that the ejector plate 826 is caused to advance to eject the molding products. After that, the ejector motor is driven to cause the ejector rods 210 to retreat at a set movement speed and to cause the ejector plate 826 to retreat up to the original standby position.

The position and the movement speed of each ejector rod 210 are measured using, for example, an ejector motor encoder. The ejector motor encoder measures rotation of the ejector motor, and sends a signal indicating a detection result thereof to the control device 700. An ejector rod position detector for measuring the position of each ejector rod 210 and an ejector rod movement speed detector for measuring the movement speed of each ejector rod 210 are not limited to the ejector motor encoder, and general detectors can be used.

### Injection Unit

In the description of the injection unit 300, unlike in the description of the mold clamping unit 100 and the description of the ejector unit 200, a moving direction of a screw 330 during filling (for example, the X-axis negative direction) will correspond to a front, and a moving direction of the screw 330 during metering (for example, the X-axis positive direction) will correspond to a rear.

The injection unit 300 is installed on a slide base 301, and the slide base 301 is disposed to be capable of advancing and retreating with respect to the injection unit frame 920. The injection unit 300 is disposed to be capable of advancing and retreating with respect to the mold unit 800. The injection unit 300 touches the mold unit 800, and fills the cavity spaces 801 formed in the mold unit 800 with a molding material. The injection unit 300 includes, for example, a cylinder 310 that heats the molding material, a nozzle 320 that is provided at a front end portion of the cylinder 310, the screw 330 that is disposed in the cylinder 310 to be capable of advancing and retreating and to be rotatable, a metering motor 340 that rotates the screw 330, an injection motor 350 that causes the screw 330 to advance and retreat, and a load detector 360 that measures a load transmitted between the injection motor 350 and the screw 330.

The cylinder 310 heats the molding material fed from a feed port 311 to the inside. The molding material includes, for example, a resin and the like. The molding material is formed in the shape of, for example, pellets and is fed to the feed port 311 in a solid state. The feed port 311 is formed at a rear portion of the cylinder 310. A cooler 312, such as a water cooling cylinder, is provided on an outer periphery of the rear portion of the cylinder 310. First heating units 313, such as band heaters, and first temperature measurers 314 are provided on the outer periphery of the cylinder 310 in front of the cooler 312.

The cylinder 310 is divided into a plurality of zones in an axial direction of the cylinder 310 (for example, the X-axis direction). The first heating unit 313 and the first temperature measurer 314 are provided in each of the plurality of zones. A set temperature is set in each of the plurality of zones, and the control device 700 controls the first heating units 313 such that temperatures measured by the first temperature measurers 314 reach the set temperatures.

The nozzle 320 is provided at the front end portion of the cylinder 310, and is pressed against the mold unit 800. Second heating units 323 and second temperature measurers 324 are provided on an outer periphery of the nozzle 320. The control device 700 controls the second heating units 323 such that the measured temperature of the nozzle 320 reaches a set temperature.

The screw 330 is disposed in the cylinder 310 to be capable of advancing and retreating and to be rotatable. In a case where the screw 330 is rotated, a molding material is fed forward along a helical groove of the screw 330. The molding material is gradually melted by heat from the cylinder 310 while being fed forward. As the liquid molding material is fed in front of the screw 330 and is accumulated in a front portion of the cylinder 310, the screw 330 is caused to retreat. After that, in a case where the screw 330 is caused to advance, the liquid molding material accumulated in front of the screw 330 is injected from the nozzle 320 and the mold unit 800 is filled with the molding material.

A backflow prevention ring 331 is attached to a front portion of the screw 330 to be capable of advancing and retreating as a backflow prevention valve that prevents backflow of the molding material flowing rearward from the front of the screw 330 in a case where the screw 330 is pushed forward.

In a case where the screw 330 is caused to advance, the backflow prevention ring 331 is pushed rearward by the pressure of the molding material accumulated in front of the screw 330 and retreats relative to the screw 330 up to a closed position (see FIG. 2) where the flow channel for a molding material is closed. Accordingly, the molding material accumulated in front of the screw 330 is prevented from flowing back to the rear.

On the other hand, in a case where the screw 330 is rotated, the backflow prevention ring 331 is pushed forward by the pressure of the molding material fed forward along the helical groove of the screw 330 and advances relative to the screw 330 up to an open position (see FIG. 1) where the flow channel for a molding material is opened. Accordingly, the molding material is fed in front of the screw 330.

The backflow prevention ring 331 may be of either a co-rotation type that is rotated together with the screw 330 or a non-co-rotation type that is not rotated together with the screw 330.

The injection unit 300 may include a drive source that causes the backflow prevention ring 331 to advance and retreat with respect to the screw 330 between the open position and the closed position.

The metering motor 340 rotates the screw 330. A drive source that rotates the screw 330 is not limited to the metering motor 340, and may be, for example, a hydraulic pump or the like.

The injection motor 350 causes the screw 330 to advance and retreat. A motion conversion mechanism that converts a rotary motion of the injection motor 350 into a linear motion of the screw 330, and the like are provided between the injection motor 350 and the screw 330. The motion conversion mechanism includes, for example, a screw shaft and a screw nut that is screwed to the screw shaft. Balls, rollers, or the like may be provided between the screw shaft and the screw nut. A drive source that causes the screw 330 to advance and retreat is not limited to the injection motor 350, and may be, for example, a hydraulic cylinder or the like.

The load detector 360 measures a load that is transmitted between the injection motor 350 and the screw 330. The measured load is converted into a pressure by the control device 700. The load detector 360 is provided in a transmission channel for a load between the injection motor 350 and the screw 330, and measures a load that acts on the load detector 360.

The load detector 360 sends a signal of the measured load to the control device 700. The load measured by the load detector 360 is converted into a pressure that acts between the screw 330 and the molding material, and is used for the control and monitoring of a pressure that is received by the screw 330 from the molding material, a back pressure that acts on the screw 330, a pressure that acts on the molding material from the screw 330, and the like.

A pressure detector that measures the pressure of the molding material is not limited to the load detector 360, and a general detector can be used. For example, a nozzle pressure sensor or a mold internal pressure sensor may be used. The nozzle pressure sensor is installed in the nozzle 320. The mold internal pressure sensor is installed in the mold unit 800.

The injection unit 300 performs a metering process, a filling process, a holding pressure process, and the like under the control of the control device 700. The filling process and the holding pressure process may also be collectively referred to as an injection process.

In the metering process, the metering motor 340 is driven to rotate the screw 330 at a set rotating speed to feed the molding material forward along the helical groove of the screw 330. Accordingly, the molding material is gradually melted. As the liquid molding material is fed in front of the screw 330 and is accumulated in a front portion of the cylinder 310, the screw 330 is caused to retreat. A rotating speed of the screw 330 is measured using, for example, a metering motor encoder 341. The metering motor encoder 341 measures rotation of the metering motor 340 and sends a signal indicating a detection result thereof to the control device 700. A screw rotating speed detector that measures the rotating speed of the screw 330 is not limited to the metering motor encoder 341, and a general detector can be used.

In the metering process, the injection motor 350 may be driven to apply a set back pressure to the screw 330 to limit the sudden retreat of the screw 330. The back pressure applied to the screw 330 is measured using, for example, the load detector 360. In a case where the screw 330 retreats up to a metering completion position and a predetermined amount of molding material is accumulated in front of the screw 330, the metering process is completed.

Positions and rotating speeds of the screw 330 in the metering process are collectively set as a series of set conditions. For example, a metering start position, a rotating speed switching position, and a metering completion position are set. These positions are arranged in this order from the front side toward the rear, and indicate starting points and end points of sections in which the rotating speeds are set. The rotating speed is set for each section. One rotating speed switching position may be set, or a plurality of rotating speed switching positions may be set. The rotating speed switching position may not be set. Further, a back pressure is set for each section.

In the filling process, the injection motor 350 is driven to cause the screw 330 to advance at a set movement speed and to fill the cavity spaces 801 formed in the mold unit 800 with the liquid molding material accumulated in front of the screw 330. The position and movement speed of the screw 330 are measured using, for example, an injection motor encoder 351. The injection motor encoder 351 measures rotation of the injection motor 350 and sends a signal indicating a detection result thereof to the control device 700. In a case where the position of the screw 330 reaches a set position, switching of the filling process to the holding pressure process (so-called V/P switching) is performed. A position where V/P switching is performed is also referred to as a V/P switching position. The set movement speed of the screw 330 may be changed depending on the position of the screw 330, a time, or the like.

Positions and movement speeds of the screw 330 in the filling process are collectively set as a series of set conditions. For example, a filling start position (also referred to as an “injection start position”), a movement speed switching position, and a V/P switching position are set. These positions are arranged in this order from the rear side toward the front, and indicate starting points and end points of sections in which the movement speeds are set. The movement speed is set for each section. One movement speed switching position may be set, or a plurality of movement speed switching positions may be set. The movement speed switching position may not be set.

An upper limit of the pressure of the screw 330 is set for each section in which the movement speed of the screw 330 is set. The pressure of the screw 330 is measured by the load detector 360. In a case where the pressure of the screw 330 is equal to or lower than a setting pressure, the screw 330 advances at a set movement speed. On the other hand, in a case where the pressure of the screw 330 exceeds the setting pressure, the screw 330 advances at a movement speed lower than the set movement speed so that the pressure of the screw 330 is equal to or lower than the setting pressure for the purpose of protecting the mold.

After the position of the screw 330 reaches the V/P switching position in the filling process, the screw 330 may be caused to temporarily stop at the V/P switching position, and the V/P switching may be then performed. Immediately before the V/P switching, instead of the screw 330 being stopped, the screw 330 may advance at a very low speed or retreat at a very low speed. Further, a screw position detector for measuring the position of the screw 330 and a screw movement speed detector for measuring the movement speed of the screw 330 are not limited to the injection motor encoder 351, and general detectors can be used.

In the holding pressure process, the injection motor 350 is driven to push the screw 330 forward to maintain the pressure of the molding material at a front end portion of the screw 330 (hereinafter, also referred to as a “holding pressure”) at a setting pressure and to push a molding material remaining in the cylinder 310 toward the mold unit 800. A shortage of molding material, which is caused by cooling shrinkage in the mold unit 800, can be replenished. The holding pressure is measured using, for example, the load detector 360. A set value of the holding pressure may be changed depending on a time that has passed from the start of the holding pressure process, or the like. A plurality of holding pressures and a plurality of holding times in which the holding pressure is held in the holding pressure process may be set, and may be collectively set as a series of set conditions.

The molding material, with which the cavity spaces 801 formed in the mold unit 800 is filled, is gradually cooled in the holding pressure process, and an inlet of the cavity spaces 801 is closed by the solidified molding material at the time of completion of the holding pressure process. This state is referred to as a gate seal, and the backflow of the molding material from the cavity spaces 801 is prevented. A cooling process is started after the holding pressure process. The molding material in the cavity spaces 801 is solidified in the cooling process. The metering process may be performed in the cooling process for the purpose of shortening a molding cycle time.

The injection unit 300 of the present embodiment is of an in-line screw type, but may be of a pre-plasticizing type or the like. A pre-plasticizing type injection unit feeds a molding material, which is melted in a plasticizing cylinder, to an injection cylinder and injects the molding material into a mold unit from the injection cylinder. A screw is disposed in the plasticizing cylinder to be rotatable and not to be capable of advancing and retreating, or a screw is disposed in the plasticizing cylinder to be rotatable and to be capable of advancing and retreating. Meanwhile, a plunger is disposed in the injection cylinder to be capable of advancing and retreating.

Further, the injection unit 300 of the present embodiment is of a horizontal type in which the axial direction of the cylinder 310 is a horizontal direction, but may be of a vertical type in which the axial direction of the cylinder 310 is a vertical direction. A mold clamping unit to be combined with a vertical type injection unit 300 may be of a vertical type or a horizontal type. Likewise, a mold clamping unit to be combined with a horizontal type injection unit 300 may be of a horizontal type or a vertical type.

### Moving Unit

In the description of the moving unit 400, as in the description of the injection unit 300, the moving direction of the screw 330 during filling (for example, the X-axis negative direction) will correspond to a front, and the moving direction of the screw 330 during metering (for example, the X-axis positive direction) will correspond to a rear.

The moving unit 400 causes the injection unit 300 to advance and retreat with respect to the mold unit 800. Further, the moving unit 400 presses the nozzle 320 against the mold unit 800 to generate a nozzle touch pressure. The moving unit 400 includes a hydraulic pump 410, a motor 420 as a drive source, a hydraulic cylinder 430 as a hydraulic actuator, and the like.

The hydraulic pump 410 includes a first port 411 and a second port 412. The hydraulic pump 410 is a pump that can be rotated in both directions, and sucks hydraulic fluid (for example, oil) from any one of the first port 411 and the second port 412 and discharges the hydraulic fluid from the other thereof to generate hydraulic pressure in a case where a rotation direction of the motor 420 is switched. The hydraulic pump 410 can also suck hydraulic fluid from a tank and discharge the hydraulic fluid from any one of the first port 411 and the second port 412.

The motor 420 causes the hydraulic pump 410 to operate. The motor 420 drives the hydraulic pump 410 in a rotation direction, which corresponds to a control signal sent from the control device 700, with rotation torque corresponding to the control signal. The motor 420 may be an electric motor or may be an electric servomotor.

The hydraulic cylinder 430 includes a cylinder body 431, a piston 432, and a piston rod 433. The cylinder body 431 is fixed to the injection unit 300. The piston 432 partitions the inside of the cylinder body 431 into a front chamber 435 as a first chamber and a rear chamber 436 as a second chamber. The piston rod 433 is fixed to the stationary platen 110.

The front chamber 435 of the hydraulic cylinder 430 is connected to the first port 411 of the hydraulic pump 410 via a first flow channel 401. In a case where hydraulic fluid discharged from the first port 411 is supplied to the front chamber 435 via the first flow channel 401, the injection unit 300 is pushed forward. The injection unit 300 advances, so that the nozzle 320 is pressed against the stationary mold 810. The front chamber 435 functions as a pressure chamber that generates the nozzle touch pressure of the nozzle 320 with the pressure of the hydraulic fluid supplied from the hydraulic pump 410.

On the other hand, the rear chamber 436 of the hydraulic cylinder 430 is connected to the second port 412 of the hydraulic pump 410 via a second flow channel 402. In a case where hydraulic fluid discharged from the second port 412 is supplied to the rear chamber 436 of the hydraulic cylinder 430 via the second flow channel 402, the injection unit 300 is pushed rearward. The injection unit 300 retreats, so that the nozzle 320 is separated from the stationary mold 810.

The moving unit 400 includes the hydraulic cylinder 430 in the present embodiment, but the present invention is not limited thereto. For example, an electric motor and a motion conversion mechanism that converts a rotary motion of the electric motor into a linear motion of the injection unit 300 may be used instead of the hydraulic cylinder 430.

### Control Device

The control device 700 is formed of, for example, a computer and includes a central processing unit (CPU) 701, a storage medium 702, such as a memory, an input interface 703, and an output interface 704 as shown in FIGS. 1 and 2. The control device 700 causes the CPU 701 to execute a program, which is stored in the storage medium 702, to perform various types of control. Further, the control device 700 receives a signal from the outside through the input interface 703, and transmits a signal to the outside through the output interface 704.

The control device 700 repeatedly performs the metering process, the mold closing process, the pressurization process, the mold clamping process, the filling process, the holding pressure process, the cooling process, the depressurization process, the mold opening process, the ejection process, and the like to repeatedly manufacture molding products. A series of operations for obtaining molding products, for example, operations from the start of a metering process to the start of the next metering process, are also referred to as a “shot” or a “molding cycle”. Further, a time required for one shot is also referred to as a “molding cycle time” or a “cycle time”.

One molding cycle includes, for example, the metering process, the mold closing process, the pressurization process, the mold clamping process, the filling process, the holding pressure process, the cooling process, the depressurization process, the mold opening process, and the ejection process in this order. The order mentioned here is an order in which the respective processes are started. The filling process, the holding pressure process, and the cooling process are performed during the mold clamping process. The start of the mold clamping process may coincide with the start of the filling process. The completion of the depressurization process coincides with the start of the mold opening process.

A plurality of processes may be simultaneously performed for the purpose of shortening a molding cycle time.

For example, a metering process may be performed during a cooling process of a previous molding cycle, or may be performed during a mold clamping process. In this case, the mold closing process may be performed at the beginning of the molding cycle. Further, the filling process may be started during the mold closing process. Furthermore, the ejection process may be started during the mold opening process. In a case where an on-off valve for opening and closing a flow channel of the nozzle 320 is provided, the mold opening process may be started during the metering process. The reason for this is that a molding material does not leak from the nozzle 320 as long as the on-off valve closes the flow channel of the nozzle 320 even though the mold opening process is started during the metering process.

One molding cycle may include processes other than the metering process, the mold closing process, the pressurization process, the mold clamping process, the filling process, the holding pressure process, the cooling process, the depressurization process, the mold opening process, and the ejection process.

For example, a pre-metering suck-back process for causing the screw 330 to retreat up to a preset metering start position may be performed before the start of the metering process after the completion of the holding pressure process. Since the pressure of the molding material accumulated in front of the screw 330 can be reduced before the start of the metering process, the sudden retreat of the screw 330 at the time of start of the metering process can be prevented.

Further, a post-metering suck-back process for causing the screw 330 to retreat up to a preset filling start position (also referred to as an “injection start position”) may be performed before the start of the filling process after the completion of the metering process. Since the pressure of the molding material accumulated in front of the screw 330 can be reduced before the start of the filling process, leakage of the molding material from the nozzle 320 before the start of the filling process can be prevented.

The control device 700 is connected to an operation unit 750 that receives an input operation performed by a user and to a display unit 760 that displays a screen. The operation unit 750 and the display unit 760 may be formed of, for example, a touch panel 770 and may be integrated with each other. The touch panel 770 as the display unit 760 displays a screen under the control of the control device 700. For example, information, such as the settings of the injection molding machine 10 and the current state of the injection molding machine 10, may be displayed on the screen of the touch panel 770. Further, for example, operation sections, such as buttons or input fields used to receive an input operation performed by a user, may be displayed on the screen of the touch panel 770. The touch panel 770 as the operation unit 750 detects an input operation performed on the screen by a user, and outputs a signal corresponding to the input operation to the control device 700. Accordingly, for example, a user can operate the operation section provided on the screen to set the injection molding machine 10 (including the input of a set value) while checking information displayed on the screen. Further, a user can operate the operation section provided on the screen to cause the operation of the injection molding machine 10, which corresponds to the operation section, to be performed. The operation of the injection molding machine 10 may be, for example, the operation (also including stopping) of the mold clamping unit 100, the ejector unit 200, the injection unit 300, the moving unit 400, or the like. Further, the operation of the injection molding machine 10 may be switching of the screen that is displayed on the touch panel 770 as the display unit 760, or the like.

The operation unit 750 and the display unit 760 of the present embodiment have been described as being integrated as the touch panel 770, but may be provided independently of each other. Further, a plurality of operation units 750 may be provided. The operation unit 750 and the display unit 760 are disposed on an operation side (Y-axis negative direction) of the mold clamping unit 100 (more specifically, the stationary platen 110).

### Details of Control Device

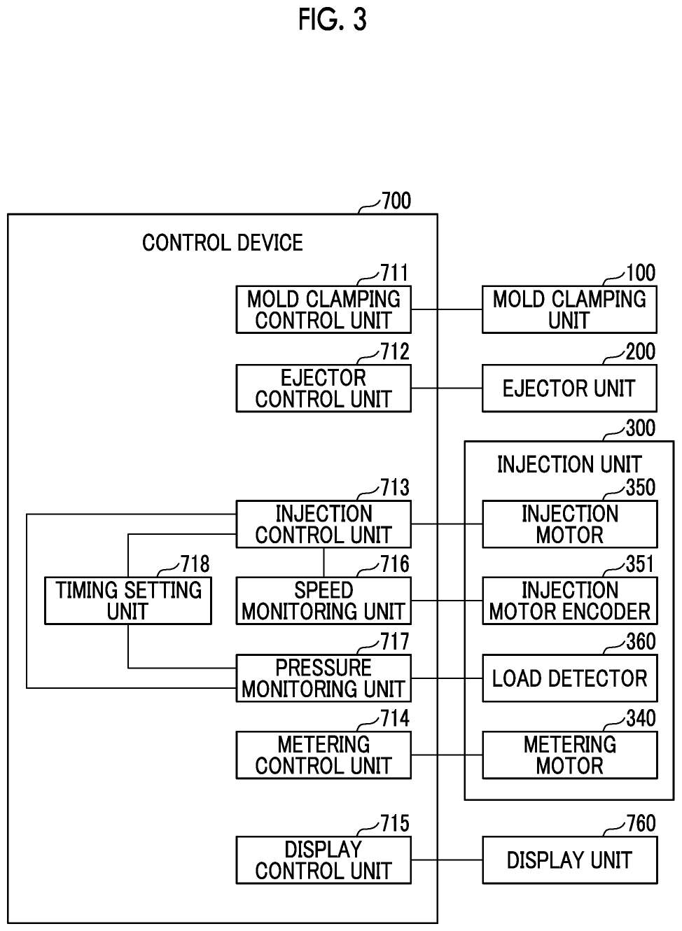

Next, an example of components of the control device 700 will be described with reference to FIG. 3. The respective functional blocks shown in FIG. 3 are conceptual and do not necessarily need to be physically configured as shown. All or a part of the respective functional blocks can be functionally or physically distributed and integrated as any unit. All or any part of each processing function performed by each functional block may be realized by a program executed by a CPU, or may be realized as hardware by a wired logic.

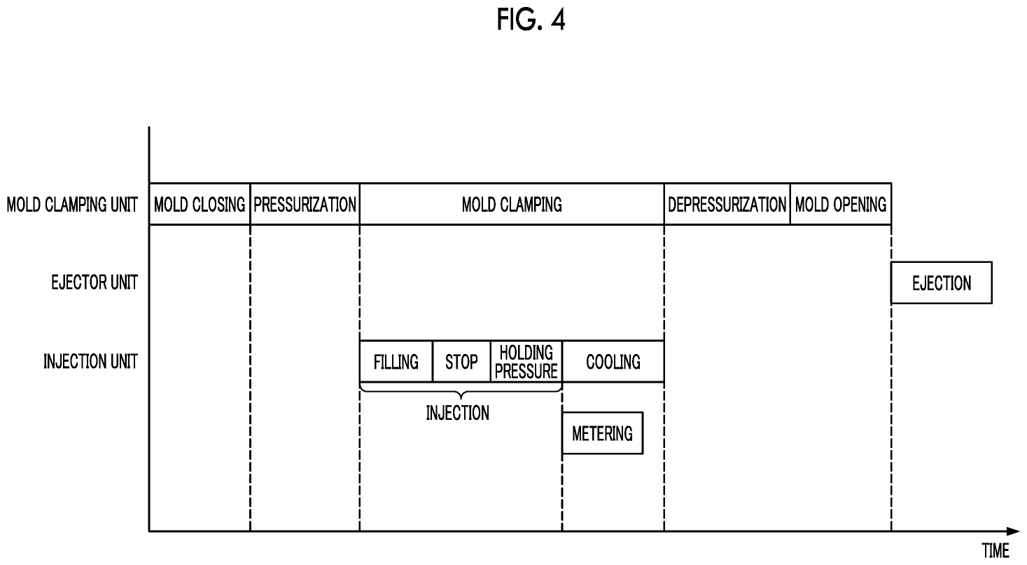

As shown in FIG. 3, the control device 700 includes, for example, a mold clamping control unit 711, an ejector control unit 712, an injection control unit 713, a metering control unit 714, and a display control unit 715. The mold clamping control unit 711 controls the mold clamping unit 100, and performs the mold closing process, the pressurization process, the mold clamping process, the depressurization process, and the mold opening process shown in FIG. 4. The ejector control unit 712 controls the ejector unit 200 and performs the ejection process. The injection control unit 713 controls an injection drive source of the injection unit 300 and performs the injection process. The injection drive source is, for example, the injection motor 350 but may be a hydraulic cylinder or the like. The metering control unit 714 controls a metering drive source of the injection unit 300 and performs the metering process. The metering drive source is, for example, the metering motor 340 but may be a hydraulic pump or the like. The metering process is performed during the cooling process. The display control unit 715 controls the display unit 760.

As shown in FIG. 4, the injection process includes the filling process, a stop process, and the holding pressure process in this order. The injection process is performed during the mold clamping process. In the injection process, a speed monitoring unit 716 monitors an actual value of a movement speed of an injection member. The injection member is a member that pushes the molding material. The molding material includes a resin. The injection member is, for example, the screw 330 but may be a plunger. The movement speed of the injection member is measured using a speed detector. The speed detector is, for example, the injection motor encoder 351. Further, in the injection process, a pressure monitoring unit 717 monitors an actual value of a pressure acting on the molding material from the injection member. The pressure is measured using a pressure detector, such as the load detector 360. A nozzle pressure sensor or a mold internal pressure sensor may be used as the pressure detector.

The filling process is a process for filling the inside of the mold unit 800 with liquid molding material, which is accumulated in front of the injection member, by moving the injection member forward. The filling process is a process for controlling the injection drive source so that, for example, the actual value of the movement speed of the injection member provided in the cylinder 310 reaches a set value. In a case where the injection member advances in the filling process, the actual value of the pressure acting on the molding material from the injection member is increased.

The stop process is a process for stopping the movement of the injection member. A time of the stop process is set in advance. Even after the movement of the injection member is stopped, the molding material flows into the mold unit 800 due to a residual pressure. Since the residual pressure is used, an excessive increase in pressure can be suppressed. As a result, molding defects, such as burrs, can be suppressed.

In a case where a time having passed from the start of the stop process reaches a time set in advance, the stop process is switched to the holding pressure process. As will be described in detail later, the stop process may be switched to the holding pressure process at a timing set by a timing setting unit 718.

The holding pressure process is a process for replenishing a shortage of molding material, which is caused by cooling shrinkage in the mold unit 800, by pushing the injection member forward. The holding pressure process is a process for controlling the injection drive source so that, for example, the actual value of the pressure acting on the molding material from the injection member reaches a set value.

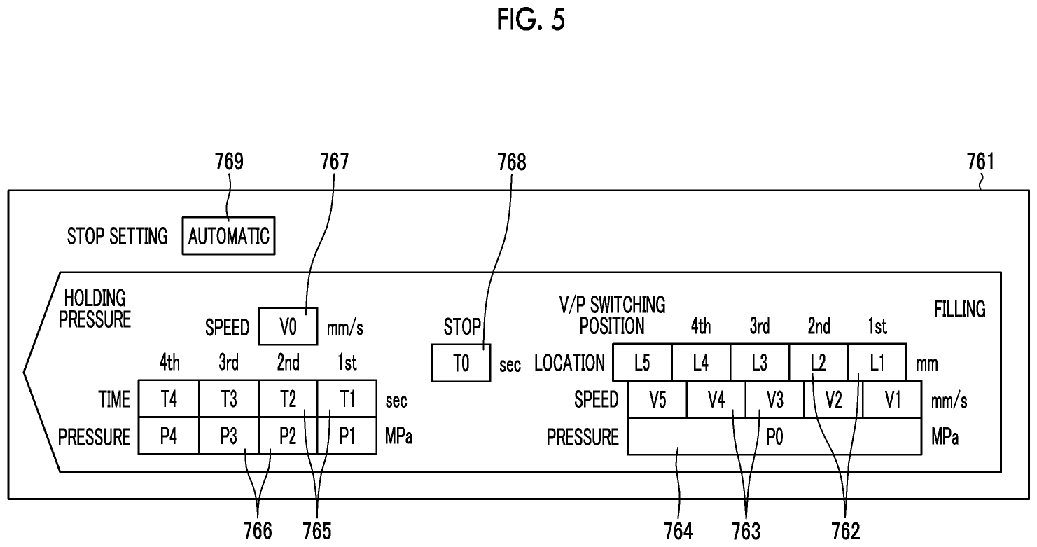

Next, an example of a screen 761 related to settings in the injection process will be described with reference to FIG. 5. The screen 761 includes input sections 762 to 769 related to the settings in the injection process. While looking at the screen 761, a user operates the operation unit 750 (see FIGS. 1 and 2) to input settings to the input sections 762 to 769. The input sections 762 to 769 display the settings, which are input to the input sections 762 to 769, as numbers, characters, or symbols. The symbols include graphic symbols.

First, settings in the filling process will be described. Settings in the filling process are input to the input sections 762, 763, and 764. Set values L1 to L5 of the position of the injection member are input to the input sections 762. The position is represented by, for example, a distance from a mechanical advance limit position of the injection member. Set values V1 to V5 of the movement speed of the injection member are input to the input sections 763. A set value P0 of the pressure acting on the molding material from the injection member is input to the input section 764.

The injection control unit 713 performs a feedback-control of the injection drive source in the filling process so that an actual value of the movement speed of the injection member reaches a set value (for example, V1), until an actual value of the position of the injection member reaches a set value (for example, L1). Further, the injection control unit 713 may correct the set value of the movement speed, and the like so that an actual value of the pressure acting on the molding material from the injection member does not exceed a set value (for example, P0).

For example, five sets of two vertically arranged input sections 762 and 763 are arranged horizontally so that a combination of the position and the movement speed can be set up to, for example, five stages in the filling process. Set values L1 to L4 of the movement speed switching position are input to the four input sections 762. A set value L5 of the V/P switching position is input to the remaining one input section 762. Set values V1 to V5 of the movement speed are input to the five input sections 763. The number of sets of input sections 762 and 763 is not limited to five.

In a case where the number of sets of input sections 762 and 763 is five, it is not necessary to use all five sets of input sections 762 and 763. Characters representing that the input section is not in use, for example, “off”, are input to each of the input sections 762 and 763 that are not in use. A fact that the input section is not in use may be represented not by characters but by symbols or blank spaces.

From the start of the filling process to the end of the filling process, the movement speed of the injection member may not be switched and the movement speed of the injection member may be constant. In that case, only a combination of the set value L5 of the V/P switching position and the set value V1 of the movement speed up to the V/P switching position needs to be input. In a case where an actual value of the position of the injection member reaches the set value L5 of the V/P switching position, the injection control unit 713 switches the filling process to the stop process.

Next, settings in the holding pressure process will be described prior to the description of settings in the stop process. Settings in the holding pressure process are input to input sections 765, 766, and 767. Set values T1 to T4 of a holding time in which the pressure acting on the molding material from the injection member is held are input to input sections 765. Set values P1 to P4 of the pressure acting on the molding material from the injection member are input to the input sections 766. A set value V0 of the movement speed of the injection member is input to the input section 767.

The injection control unit 713 performs the feedback-control of the injection drive source in the holding pressure process so that an actual value of the pressure reaches a set value (for example, P1), until an actual value of the holding time reaches a set value (for example, T1). Further, the injection control unit 713 may correct the set value of the pressure, and the like so that the movement speed (an advance speed or a retreat speed) of the injection member does not exceed a set value (for example, V0). An input section 767 to which a set value of the advance speed is to be input and an input section 767 to which a set value of the retreat speed is to be input may be provided separately.

For example, four sets of two vertically arranged input sections 765 and 766 are arranged horizontally so that a combination of the holding time and the pressure can be set up to, for example, four stages in the holding pressure process. The number of sets of input sections 765 and 766 is not limited to four. Further, in a case where the number of sets of input sections 765 and 766 is four, it is not necessary to use all four sets of input sections 765 and 766. From the start of the holding pressure process to the end of the holding pressure process, the pressure may not be switched and the pressure may be constant. In that case, only one combination of the set value of the pressure and the set value of the holding time needs to be input.

Next, settings in the stop process will be described. Settings in the stop process are input to the input sections 768 and 769. A set value T0 of the time of the stop process is input to the input section 768. A setting of whether or not to switch the stop process to the holding pressure process at the timing set by the timing setting unit 718 is input to the input section 769.

The input section 769 displays a plurality of candidates using, for example, a pull-down menu. Examples of the plurality of candidates include “automatic” and “time”. The user selects one candidate from the plurality of candidates to input a setting. The input section 769 may be a changeover switch instead of a pull-down menu. Whenever the user pushes the changeover switch, a setting may be changed and a display may be changed.

In a case where the display of the input section 769 is, for example, “time”, the injection control unit 713 switches the stop process to the holding pressure process according to the set value T0 input by the user. Specifically, in a case where an actual value of a time having passed from the start of the stop process reaches the set value T0, the injection control unit 713 switches the stop process to the holding pressure process. On the other hand, in a case where the display of the input section 769 is, for example, “automatic”, the injection control unit 713 switches the stop process to the holding pressure process at the timing set by the timing setting unit 718.

A setting of whether or not to switch the stop process to the holding pressure process at the timing set by the timing setting unit 718 may be made automatically instead of manually, or may be made autonomously by the control device 700. In a case where the set value T0 of a time of the stop process is appropriate, the injection control unit 713 may switch the stop process to the holding pressure process according to the set value T0 input by the user.

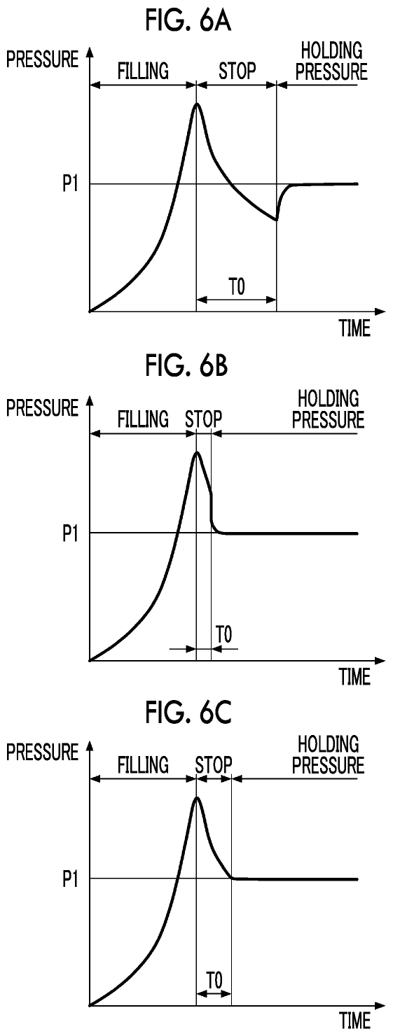

Next, an actual value of the pressure in the injection process will be described with reference to FIGS. 6A, 6B, and 6C. FIGS. 6A and 6B show a change in an actual value of the pressure in a case where the injection control unit 713 switches the stop process to the holding pressure process according to the set value T0 input by the user. FIG. 6C shows a change in an actual value of the pressure in a case where the injection control unit 713 switches the stop process to the holding pressure process at the timing set by the timing setting unit 718.

In a case where the set value T0 of a time of the stop process is excessively large as shown in FIG. 6A, an actual value of the pressure at the time of completion of the stop process is smaller than a set value P1 of the pressure at the time of start of the holding pressure process. In this case, the pressure for pushing the resin in the stop process is excessively low, so that a flow of the resin may be excessively slow. As a result, for example, a defect in which a part of a molding product is not formed since the resin is not distributed into the mold unit 800, that is, a so-called short shot, may occur.

In a case where the set value T0 of a time of the stop process is excessively small as shown in FIG. 6B, an actual value of the pressure at the time of completion of the stop process is larger than a set value P1 of the pressure at the time of start of the holding pressure process. In this case, the injection member may be caused to suddenly retreat so that an actual value of the pressure is reduced after the stop process is switched to the holding pressure process. As a result, for example, a defect in which a surface of the molding product is dented, that is, a so-called sink mark, may occur.

In a case where the set value T0 of a time of the stop process is appropriate as shown in FIG. 6C, an actual value of the pressure at the time of completion of the stop process coincides with a set value P1 of the pressure at the time of start of the holding pressure process within a margin of error. The margin of error is a range of, for example, −5% to 5%. An actual value of the pressure continuously changes from the stop process to the holding pressure process. In this case, since the pressure for pushing the resin in the stop process is appropriate, molding defects can be suppressed.

The timing setting unit 718 sets a timing when the stop process is to be switched to the holding pressure process on the basis of an actual value of the pressure in the stop process and a value (P1+ΔP) offset from the set value P1 of the pressure at the time of start of the holding pressure process to a high pressure side by a predetermined amount ΔP. ΔP is set in advance on the basis of the amount of reduction in an actual value in the pressure that is caused by a control delay (time lag), and is stored in advance in the storage medium 702. Accordingly, since an actual value of the pressure can continuously change from the stop process to the holding pressure process, molding defects can be suppressed. Further, since the user of the injection molding machine 10 does not need to set a time of the stop process, labor of the user can be reduced.

The timing setting unit 718 may set a timing when the stop process is to be switched to the holding pressure process in an n-th shot on the basis of an actual value of the pressure in the stop process of the n-th shot and the value (P1+ΔP) offset from the set value P1 of the pressure at the time of start of the holding pressure process to a high pressure side by a predetermined amount ΔP. Since an actual value of the pressure can continuously change from the stop process to the holding pressure process even in a case where an actual value of the pressure in the stop process varies for each shot, molding defects can be suppressed.

For example, the timing setting unit 718 may set a timing when an actual value of the pressure reaches the value (P1+ΔP) offset from the set value P1 of the pressure at the time of start of the holding pressure process to a high pressure side by a predetermined amount ΔP as a timing when the stop process is to be switched to the holding pressure process, in the stop process of an n-th shot.

The timing setting unit 718 may set a time of the stop process of an (n+1)-th or subsequent shot on the basis of an actual value of the pressure in the stop process of an n-th shot and the value (P1+ΔP) offset from the set value P1 of the pressure at the time of start of the holding pressure process to a high pressure side by a predetermined amount ΔP. Since a time of the stop process is determined before the start of the stop process, a calculation load of the control device 700 can be reduced. The timing setting unit 718 updates the setting of a time of the stop process whenever the set value P1 is changed or whenever a shot is performed a predetermined number of times.

For example, the timing setting unit 718 may set a time of the stop process of an (n+1)-th or subsequent shot on the basis of a time when an actual value of the pressure in the stop process of an n-th shot reaches the value (P1+ΔP) offset from the set value P1 of the pressure at the time of start of the holding pressure process to a high pressure side by a predetermined amount ΔP. A time of the stop process of an (n+1)-th or subsequent shot is set to the same time as a time when an actual value of the pressure reaches the value (P1+ΔP) offset from the set value P1 to a high pressure side by a predetermined amount ΔP in the stop process of an n-th shot.

The timing setting unit 718 may use the set value P1 of the pressure at the time of start of the holding pressure process instead of the value (P1+ΔP) offset from the set value P1 of the pressure at the time of start of the holding pressure process to a high pressure side by a predetermined amount ΔP. In a case where the amount of reduction in an actual value in the pressure caused by a control delay (time lag) is negligible, the set value P1 may be used instead of the offset value (P1+ΔP).

The screen 761 may be provided with an input section to which a setting of whether or not the timing setting unit 718 uses the offset value (P1+ΔP) is to be input, that is, an input section to which a setting of whether the timing setting unit 718 uses the set value P1 or the offset value (P1+ΔP) is to be input. Switching between the set value P1 and the offset value (P1+ΔP) may be performed automatically instead of manually, or may be performed autonomously by the control device 700.

A time of the stop process of an (n+1)-th or subsequent shot may be set to a time that is shortened from a time when an actual value of the pressure reaches the set value P1 by a predetermined time in the stop process of an n-th shot. The amount of reduction in time is determined in consideration of a control delay.

The set value P1 is a value set by a user in the present embodiment, but may be a value calculated on the basis of a user's setting. For example, in a case where a user sets a target value of a physical quantity (for example, the quality of a molding product, or the like) other than the pressure, the control device 700 may autonomously calculate the set value P1 so that the physical quantity reaches the target value. A publicly known method can be used as a method of calculating the set value P1.

The control device of the injection molding machine, the injection molding machine, and a method of controlling the injection molding machine according to the embodiments of the present invention have been described above, but the present invention is not limited to the above-mentioned embodiments and the like. Various modifications, corrections, substitutions, additions, deletions, and combinations can be made within the scope of the appended claims. Naturally, those also belong to the technical scope of the present invention.

It should be understood that the invention is not limited to the above-described embodiment, but may be modified into various forms on the basis of the spirit of the invention. Additionally, the modifications are included in the scope of the invention.

What is claimed is:

1. A control device of an injection molding machine including an injection member that pushes a molding material and an injection drive source that moves the injection member, the control device comprising:
an injection control unit that controls a stop process for stopping a movement of the injection member and a holding pressure process for controlling a pressure acting on the molding material from the injection member;
a pressure monitoring unit that monitors an actual value of the pressure in the stop process; and
a timing setting unit that sets a timing when the stop process is to be switched to the holding pressure process on the basis of the actual value of the pressure in the stop process and a value offset from a set value of the pressure at a time of start of the holding pressure process to a high pressure side by a predetermined amount.

2. The control device of an injection molding machine according to claim 1,
wherein the set value of the pressure at the time of start of the holding pressure process is a value set by a user or a value calculated on the basis of a user's setting.

3. The control device of an injection molding machine according to claim 1,
wherein the timing setting unit sets a timing when the stop process is to be switched to the holding pressure process in an n-th shot on the basis of an actual value of the pressure in the stop process of the n-th shot and the value offset from the set value of the pressure at the time of start of the holding pressure process to the high pressure side by the predetermined amount.

4. The control device of an injection molding machine according to claim 3,
wherein the timing setting unit sets a timing when the actual value of the pressure reaches the value offset from the set value of the pressure at the time of start of the holding pressure process to the high pressure side by the predetermined amount in the stop process of the n-th shot as the timing when the stop process is to be switched to the holding pressure process.

5. The control device of an injection molding machine according to claim 1,
wherein the timing setting unit sets a time of the stop process of an (n+1)-th or subsequent shot on the basis of an actual value of the pressure in the stop process of an n-th shot and the value offset from the set value of the pressure at the time of start of the holding pressure process to the high pressure side by the predetermined amount.

6. The control device of an injection molding machine according to claim 5,
wherein the timing setting unit sets the time of the stop process of the (n+1)-th or subsequent shot on the basis of a time when the actual value of the pressure in the stop process of the n-th shot reaches the value offset from the set value (P1) of the pressure at the time of start of the holding pressure process to the high pressure side by the predetermined amount.

7. The control device of an injection molding machine according to claim 1,
wherein a setting of whether or not the timing setting unit uses the value offset from the set value of the pressure at the time of start of the holding pressure process to the high pressure side by the predetermined amount is switchable.

8. The control device of an injection molding machine according to claim 7, further comprising:
a display control unit that controls a display unit to cause the display unit to display an input section to which a setting of whether or not the timing setting unit uses the value offset from the set value of the pressure at the time of start of the holding pressure process to the high pressure side by the predetermined amount is to be input.

9. The control device of an injection molding machine according to claim 1,
wherein a setting of whether or not the injection control unit switches the stop process to the holding pressure process at the timing set by the timing setting unit is switchable.

10. The control device of an injection molding machine according to claim 9, further comprising:
a display control unit that controls a display unit to cause the display unit to display an input section to which a setting of whether or not the injection control unit switches the stop process to the holding pressure process at the timing set by the timing setting unit is to be input.

11. An injection molding machine comprising:
the control device according to claim 1;
the injection member; and
the injection drive source.

12. A method of controlling an injection molding machine including an injection member that pushes a molding material and an injection drive source that moves the injection member, the method comprising:
a step of controlling a stop process for stopping a movement of the injection member and a holding pressure process for controlling a pressure acting on the molding material from the injection member;
a step of monitoring an actual value of the pressure in the stop process; and
a step of setting a timing when the stop process is to be switched to the holding pressure process on the basis of the actual value of the pressure in the stop process and a value offset from a set value of the pressure at a time of start of the holding pressure process to a high pressure side by a predetermined amount.
